(19) United States
(12) Patent Application Publication
(10) Pub. No.: US 2012/0304124 A1
(43) Pub. Date: Nov. 29, 2012

(54) CONTEXT AWARE INPUT ENGINE

(75) Inventors: Liang Chen, Redmond, WA (US); ITAI ALMOG, REDMOND, WA (US); HEESUNG KOO, KIRKLAND, WA (US); JEFFREY C. FONG, SEATTLE, WA (US)

(73) Assignee: MICROSOFT CORPORATION, REDMOND, WA (US)

(21) Appl. No.: 13/225,081

(22) Filed: Sep. 2, 2011

Related U.S. Application Data
(60) Provisional application No. 61/489,142, filed on May 23, 2011.

(51) Int. Cl. G06F 3/048

(52) U.S. Cl. 715/825

(57) ABSTRACT

Context aware input engines are provided. Through the use of such engines, various input elements may be determined based on analyzing context. A variety of contexts may be analyzed in determining input elements. Contexts may include, for example, a communication recipient, a location, a previous user interaction, a computing device being utilized, or any combination thereof. Such contexts may be analyzed to advantageously provide an input element to a user. Input elements may include, for example, an onscreen keyboard of a certain layout, an onscreen keyboard of a certain language, a certain button, a voice recognition module, or text-selection options. One or more such input elements may be provided to the user based on analyzed context.

### CROSS-REFERENCE TO RELATED APPLICATIONS

This application claims the benefit of U.S. Provisional Application No. 61/489,142, filed May 23, 2011, which is herein incorporated by reference in its entirety.

### BACKGROUND

Obtaining user input is an important aspect of computing. User input may be obtained through a number of interfaces such as keyboard, mouse, voice-recognition, or touch-screen. Some devices allow for multiple interfaces through which user input may be obtained. For example, touch-screen devices allow for the presentation of different graphical interfaces, either simultaneously or separately. Such graphical touch-screen interfaces include onscreen keyboards and text-selection fields. Accordingly, a computing device may have the ability to provide different input interfaces to obtain input from a user.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

Embodiments of the present invention relate to providing input elements to a user based on analyzing context. Context that may be analyzed include, but are not limited to, one or more intended communication recipients, language selection, application selection, location, and device. Context may be associated with one or more input elements. Context may be analyzed to determine one or more input elements to preferentially provide to the user for obtaining input. The one or more input elements may then be provided to the user for display. The user may provide input via the input element, or may interact to indicate that the input element is not desired. User interactions may be analyzed to determine an association between input elements and contexts. Such associations may be analyzed to determine to provide one or more input element to a user.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a flow diagram that illustrates a method for providing context aware input elements to a user;

FIG. 3 is a diagram showing contexts suitable for use with embodiments of the present invention;

FIG. 4 is another flow diagram that illustrates a method for providing context aware input elements to a user;

FIG. 5 is a diagram showing a system for providing context aware input elements to a user;

FIG. 6 is a screen display showing an embodiment of the present invention; and

FIG. 7 is another screen display showing an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention are generally directed to providing input elements to a user based on an analysis of context. As used herein, the term “context” generally refers to conditions that may be sensed by a computing device. Context may include an intended communication recipient for email, SMS, or instant message. Context may also include, for example, location, an application in currently being used, an application previously used, or previous user interactions with an application. Additionally, as used herein, the term “input element” means an interface, portion of an interface, or configuration of an interface for receiving input. An onscreen keyboard may be an input element, for example. A particular button of an onscreen keyboard may also be an input element. A text-selection field may be yet another example of an input element, as may be a word included within a text-selection field. The term “word,” as used herein, refers to a word, abbreviation, or any piece of text. The term “dictionary,” as used herein, refers generally to a grouping of words. Dictionaries may include, for example, default dictionaries of English language words, dictionaries built through received user input, one or more tags associating a group of words with a particular context, or any combination thereof. A specific dictionary means, in general, a dictionary that has been associated, at least in part, with one or more contexts. A broad dictionary, in general, means a dictionary that has not been specifically associated with one or more contexts.

In accordance with embodiments of the present invention, where user input is to be obtained, it may make sense to provide certain input elements to a user. For instance, a user may be typing on a touch-screen utilizing an onscreen keyboard. Upon detection of a possible misspelling, it may make sense to present the user with a list of words from which to choose. It may also make sense to analyze context in determining to provide what input elements to the user. For example, in a certain context, it may be more likely that the user intended one word over another. In such a situation, it may be advantageous to present the more likely word to the user instead of the less likely word. Alternatively, the words could both be presented utilizing rankings to reflect their likelihood.

A given context may be associated with a given input element. This association of contexts with input elements may occur in a number of ways. For example, upon first opening an email application, the user may be presented with an English-language keyboard. The user may take steps to choose a Spanish-language keyboard. Accordingly, the context of opening an email application may be associated with the input element “Spanish-language keyboard.” Later, the email application context may be analyzed to determine to provide a Spanish-language keyboard to the user. Upon further use of the email application, it may be determined that the user often switches from the Spanish-language keyboard to the English-language keyboard when composing an email to email address “mark@live.com.” Accordingly, the “mark@live.com” email address may be determined to be context that is useful when determining the appropriate input element to provide to the user.

There may be multiple contexts to by analyzed in any given situation. For example, the application currently in use, together with an intended communication recipient, may be analyzed in determining the appropriate input element to provide. In the above situation, for example, it may be determined to present the Spanish-language keyboard by default to the user when using the email application. However, when the user is composing a message to “mark@live.com,” it may be determined to provide the English-language keyboard to the user. When another application is in use, such as a word processing application, it may be determined to provide a voice recognition interface to the user by default, regardless of the intended recipient of the document being composed. Thus, in certain situations, multiple contexts may be analyzed in order to determine the appropriate input element or input elements to present to a user.

In some embodiments, an appropriate input element may be identified through the utilization of an API. For example, an application may receive an indication from a user that a communication is to be made with a certain communication recipient. The application may submit this context to an API provided, for example, by an operating system. The API may then respond by providing the application with an appropriate input element. For example, the API may provide the application with an indication that a Chinese-language keyboard is an appropriate input element to utilize when composing a communication to the particular communication recipient. The API may also gain information regarding associating input elements with certain contexts. For example, the API may be requested to present a certain input element. The API may analyze the context in which the request was made in order to associate certain contexts with certain input elements. Later, the API may utilize this information when requested to provide an input element to a user in a given context. In this manner, multiple applications may gain the benefit of associating certain contexts with certain input elements.

Accordingly, in one aspect, an embodiment of the present invention is directed to one or more computer storage media storing computer-useable instructions that, when used by one or more computing devices, cause the one or more computing devices to perform a method. The method includes analyzing a user interaction to associate an input element with a first context. The method also includes analyzing a second context to determine to provide the input element to a first user. The method still further includes providing the input element to the first user.

In another aspect, an embodiment of the present invention is directed to a computing device. The computing device includes an input device for receiving input from a user. The computing device also includes one or more processors configured to execute a method. This method includes analyzing a first context to determine a first dictionary associated with the first context. The method also includes analyzing the data obtained from the input device to select a first word from the first dictionary. The method still further includes providing the first word to the user as a selection-option. The computing device also includes a display device configured to present the first selection-option to the user.

In a further aspect, another embodiment of the present invention is directed to an input element presentation system including one or more computing devices having one or more processors and one or more computer storage media. The input element presentation system includes a context identification component. The input element presentation system also includes an association component for associating one or more contexts with one or more input elements. The input element presentation system further includes an input element identification component for identifying input elements based on analyzing contexts. The input element presentation system still further includes a presentation component for presenting input elements to a user.

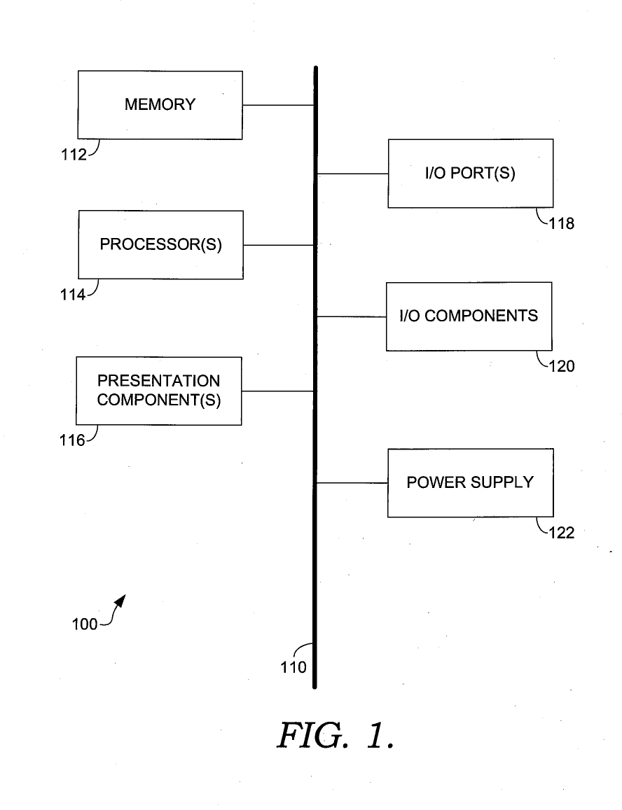

Having briefly described an overview of embodiments of the present invention, an exemplary operating environment in which embodiments of the present invention may be implemented is described below in order to provide a general context for various aspects of the present invention. Referring initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

The invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. The invention may be practiced in a variety of system configurations, including hand-held devices, consumer electronics, general-purpose computers, more specialty computing devices, etc. The invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output (I/O) ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Also, processors have memory. The inventors recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

Computing device 100 typically includes a variety of computer-readable media. Computer-readable media can be any available media that can be accessed by computing device 100 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

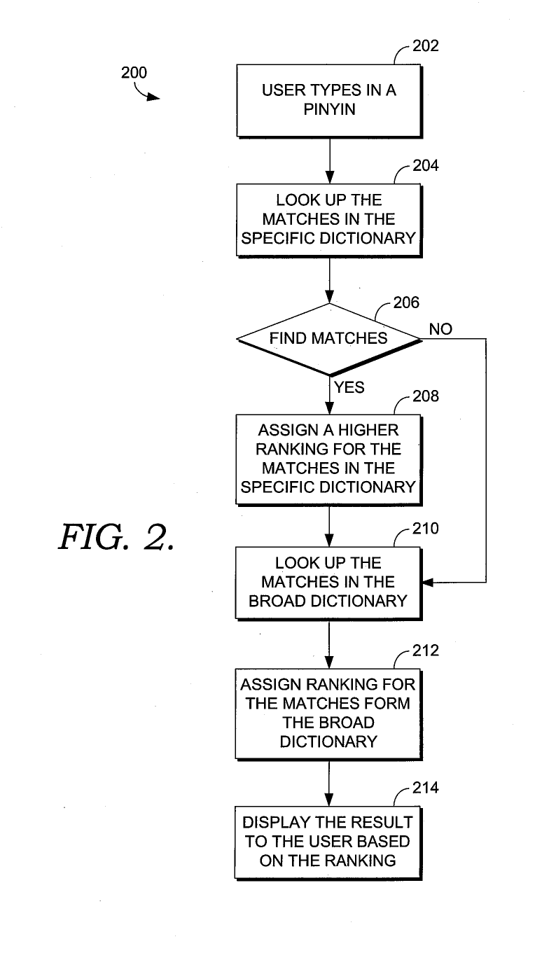

Referring now to FIG. 2, a flow diagram is provided that illustrates a method 200 for providing context aware input elements to a user. As shown at block 202, a user inputs a pinyin into a computing device. The computing device may determine one or more contexts. For example, the user may be using a mobile device to compose an email message to a friend. As shown at block 204, a dictionary specific to the communication recipient may be analyzed in order to locate matches for the pinyin. As shown at block 206, matches may be found for the pinyin. For example, certain words may be preferentially used with a certain communication recipient, and such words may be associated with the communication recipient. The associations between a communication recipient and words used with that particular communication recipient is a type of specific dictionary. In some cases, no matches may be found, in which case a broad dictionary may be analyzed, as shown at block 210. A broad dictionary may be non-specific, or may simply be less specific than the first (for example, specific to a group of communication recipients). In some cases, matches may be found at block 206. In such a case, as shown at block 208, rankings are assigned to the matches from the specific dictionary. As shown at block 210, a broad dictionary is also analyzed to determine matches to the pinyin. As shown at block 212, rankings are assigned to the matches from the broad dictionary. Typically, rankings for words appearing in the specific dictionary will be higher than rankings for words appearing only in the broad dictionary, as the words from the specific dictionary are likely to be specifically relevant to the context. As shown at block 214, the words are provided to the user for display.

For instance, a user may instantiate an email application and be provided with a recipient field. The user may input a communication recipient into the recipient field—for instance, an email address associated with a friend of the user named “Mark.” The user may then begin entering a pinyin into a message field at block 202. There may be a specific dictionary associated with Mark. Thus, at block 204, this specific dictionary is analyzed to determine matches for the pinyin. At block 206, it is determined that there are two matches for the pinyin. At block 208, these two matches are ranked. At block 210, a broad dictionary is analyzed to determine further matches for the pinyin. In this case, the broad dictionary is a dictionary that is not specific to Mark. At block 212, the matches from the broad dictionary are ranked. In this case, because there are matches from a dictionary specific to Mark, the matches from the broad dictionary will be ranked lower than the matches from the specific dictionary. As shown at block 214, the matches are provided to the user. The matches most likely to be desirable to the user are ranked in a higher position because they are specific to the context.

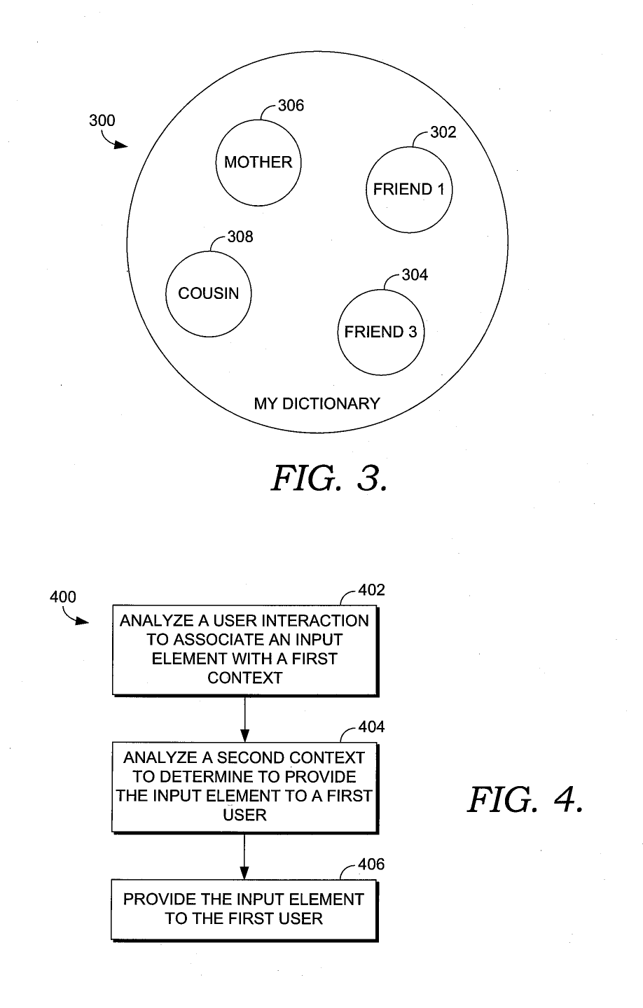

Referring now to FIG. 3, a diagram showing contexts suitable for use with embodiments of the present invention is depicted. A broad dictionary 300 is depicted. Within and among this broad dictionary are specific dictionaries, including “friend 1” specific dictionary 302, “friend 3” specific dictionary 304, “mother” specific dictionary 306, and “cousin” specific dictionary 308. While these specific dictionaries are depicted as distinct and as subsets of broad dictionary 300, they may include overlap among themselves and extend beyond broad dictionary 300. For example, certain words may be associated with “mother” specific dictionary 306 and “cousin” specific dictionary 308. Additionally, some words may be associated with “mother” specific dictionary 306 but not with broad dictionary 300. The associations between words and contexts may also be weighted. For example, the word “home” may be strongly associated with “mother” specific dictionary 306, but only weakly associated with “cousin” specific dictionary 308. The word “home” may not be associated with “friend 1” specific dictionary 302 at all, and may even be negatively associated with “friend 3” specific dictionary 304. These association weights may be utilized in analyzing context to determine what input elements to provide. These association weights may also be utilized to determine a level of similarity between two or more contexts, and to thus create associations between such contexts. Association strengths may be determined algorithmically in a number of ways. For example, association strengths may be determined by frequency of usage within a given context, or by probability or inference.

Broad dictionary 300 may be a default dictionary of commonly used English-language words, for example. A user may use an SMS application to type messages to various communication recipients. These messages may contain various words. Certain of these words may appear more frequently in certain contexts than in others. For example, the user may commonly use the word “Lol” with her cousin. This word may be rarely used with her mother, however. The word “Lol” may thus be associated with the context of the cousin as a communication recipient, and could, for instance, become part of “cousin” specific dictionary 308. The word “Lol” may also be associated with the context of using the SMS application. Later, the context of composing a message to the “cousin” as a communication recipient may be analyzed to determine to provide the word “Lol” as an input element of a text-selection field. This might occur within the context of the SMS application, or might occur within the context of an email application. It should be noted that the word “Lol” may have existed in broad dictionary 300 and merely become associated with the context of the cousin as a communication recipient, or the word may have not existed in broad dictionary 300 and was added after the user had used inputted it previously.

Referring now to FIG. 4, a flow diagram is provided that illustrates a method 400 for providing context aware input elements to a user. Initially, as shown at block 402, a user interaction is analyzed to associate an input element with a first context. For example, the user interaction may be the selection of an input element—for instance, the selection of a Chinese-language onscreen keyboard. This user interaction may have occurred while using a geo-tagging application in Beijing, China. Accordingly, the Chinese-language onscreen keyboard is associated with the use of the geo-tagging application, as shown at block 402. It should also be noted that the Chinese-language onscreen keyboard may be associated with Beijing, China, either alternatively or in addition to being associated with the geo-tagging application. As shown at block 404, a second context is analyzed to determine to provide an input element to a first user. It should be noted that the second context may be the same or different than the first context. For instance, the second context may be the location of Beijing, China, and accordingly it is determined to provide the Chinese-language onscreen keyboard to a first user. Alternatively, it may be determined that the location is San Francisco, Calif., but that the user is in a Chinese-language area of San Francisco. In this latter case, it may be determined that, although the second context is not the same as the first context, there is an association between the two such that it makes sense to provide the Chinese-language keyboard to the user, as shown at block 406.

It should be noted that there are a number of ways in which a first context may be associated with an input element. For example, the first user may use certain words when composing email messages to his mother as a communication recipient. Such a user interaction may be analyzed to associate input elements with context. For instance, the user may often type the name of his aunt “Sally” when composing email messages to his mother. This user interaction may be analyzed to associate input element “Sally” with the context of the user's mother as a communication recipient, as shown at block 402. Later, the user may begin typing the letters “SA” while composing an instant message to his mother. This second context may be analyzed to determine to provide the word “Sally” as a selection-option to the user, as shown at block 404. Thus, “Sally” is presented as an input element to the user, as shown at block 406.

It should also be considered that multiple input elements may be provided to the user. For instance, in the example above, the user might also have often typed the word “sailboat” when composing messages to his mother. The user might also have typed the word “Samir” when composing messages to his friend Bill, but never when composing messages to his mother. It might be determined that, based on the communication recipient “mother,” it is most likely that the user intends to type the word “Sally.” It may also be determined that it is next most likely that the user intends to type the word “sailboat,” and that, because the user has not previously used the word “Samir” when communicating with “mother,” it is unlikely that the user intends to type the word “Samir.” Each of these words may be ranked according to the likelihood of the user's intention, and presented to the user for display according to their rank.

In general, multiple types of input elements may be identified and presented to the user. For instance, a user might typically use an English-language keyboard when composing emails, but may sometimes choose a Chinese-language keyboard when composing SMS messages. In addition to this, the user may utilize a specific set of words when communicating with his brother. For instance, the user may often use the word “werd” when communicating with his brother. Each of these user interactions may be analyzed to associate context with input elements. Later, the user may be composing an email message to his brother. This context may be analyzed, and a English-language keyboard may be presented. While still using the email application to compose an email to his brother, the user may enter the input sequence “we.” This additional layer of context may be analyzed, and the word “werd” may be determined to be presented as an input element in a text-selection field. Thus, both the English-language onscreen keyboard and the “werd” text-selection field may be presented, either simultaneously or concurrently, as input elements.

It should also be noted that multiple user interactions may be analyzed to associate input elements with contexts. For instance, a user may choose an English-language keyboard when first using an email application. This user interaction may be provided to the operating system through an API. The API may associate the context of the email application with the input element of an English-language keyboard. The second time the user interacts with the email application, however, he may choose a Chinese-language keyboard. This user interaction may also be provided to the operating system API for association. Thus, there would be two user interactions that may be analyzed in determining the appropriate input element to provide to the user. Over the course of 100 uses of text applications, a user may choose a Chinese-language keyboard 80 times, and may choose an English-language keyboard 20 times. The API may analyze this information to determine to provide the Chinese-language keyboard to the user when first opening an SMS application. The user may enter information indicating a particular communication recipient, and this information may be provided to the API. It may be determined that, out of 20 email messages composed to that particular communication recipient, 20 have been composed using an English-language keyboard. Thus, the API may inform the SMS application that the user should be provided with the English-language keyboard. Thus, multiple user behaviors may be analyzed to determine the most appropriate input element to provide to a user.

Additionally, user behaviors from multiple users may be analyzed in associating contexts with input elements. For instance, user behaviors may be transmitted to a web server. In a specific example, a mobile-phone application may allow for users to post messages to the internet. With each post, the mobile-phone application may transmit both the message and the mobile phone location. The web server receiving this data may associate certain words contained within messages with certain locations. For instance, a first user may be in New Orleans, La. and may use the application to compose the message “At Café Du Monde!” The web server may thus associates the word sequence “Café Du Monde” with the location of New Orleans, La. A second user may be in Paris, France and may use the application to compose the message “Café Du Marche is the best bistro in France.” The web server may associate the word sequence “Café Du Marche” with the location of Paris, France. Later, a third user may be in New Orleans, La. and may begin composing a message with the letter sequence, “Café Du M.” This sequence may be sent to the web server, which can analyze this sequence and the location of New Orleans, La. to determine to provide the input element “Monde” to the third user.

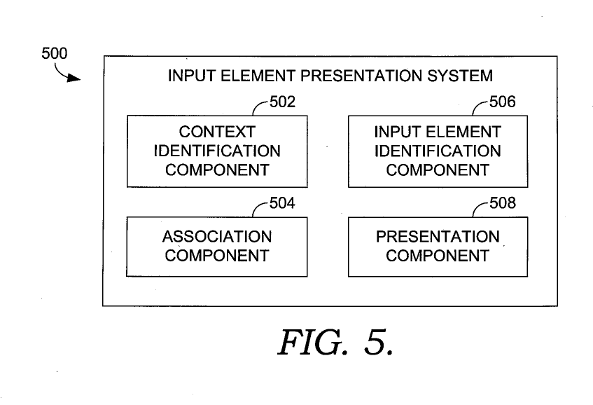

Referring now to FIG. 5, a block diagram is provided illustrating an exemplary input element presentation system 500 in which embodiments of the present invention may be employed. It should be understood that this and other arrangements described herein are set forth only as examples. Other arrangements and elements (e.g., machines, interfaces, functions, orders, components, and groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by one or more entities may be carried out by hardware, firmware, and/or software. For instance, various functions may be carried out by a processor executing instructions stored in memory.

The input element presentation system 500 may include context identification component 502, an association component 504, an input element identification component 506, and a presentation component 508. The system may be comprised of a single computing device, or may encompass multiple computing devices linked together via a communications network. In addition, each of the components may include any type of computing device, such as computing device 100 described with reference to FIG. 1, for example.

Generally, context identification component 502 identifies contexts that may be associated with input elements. For instance, context identification component 502 may identify communication recipients, locations, applications in use, direction of travel, groups of communication recipients, etc. Input element identification component 506 may identify a number of input elements. For instance, there may be keyboards configured for English-language input, Spanish-language input, Chinese-language input, etc. In addition, there may be multiple configurations for each of these keyboard depending on the type of input desired, or, if using a touch-screen device, whether the device is oriented in portrait mode or landscape mode. There may also be various specific or broad dictionaries from which words may be identified as input elements. Categories of input elements may also be identified, such as “English-languge” input elements. Such categories of input elements may be used to group types of input elements together. A context, as identified by context identification component 502, may be associated with one or more input elements, as identified by input element identification component 506, via association component 504. The presentation component 508 may then be utilized to provide one or more input elements to the user for display.

For example, a user may use an application with a “share” feature, and may indicate that the user desires to share certain information with her friend Mary. The “share” feature of the application may be identified as context by context identification component 502. Additionally, the friend Mary may be identified as context by context identification component 502. The user may then proceed to the “message” field and be presented with an English-language keyboard. The English-language keyboard may be identified as an input element by input element identification component 506. The user may choose to use a Spanish-language keyboard. The Spanish-language keyboard is also identified by input element identification component 506. Association component 504 may associate the Spanish-language keyboard with the context of Mary as a communication recipient. Association component 504 may also associated the Spanish-language keyboard with the context of the “share” feature of this application. Thus, appropriate input elements may be determined. For example, at a later time, a user may utilize the “share” feature of the application. This “share” feature may be identified as context by context identification component 502. This context may utilized by input element identification component 506 to identify that a Spanish-language keyboard may be advantageously presented to the user. The Spanish-language keyboard may then be presented to the user via presentation component 508.

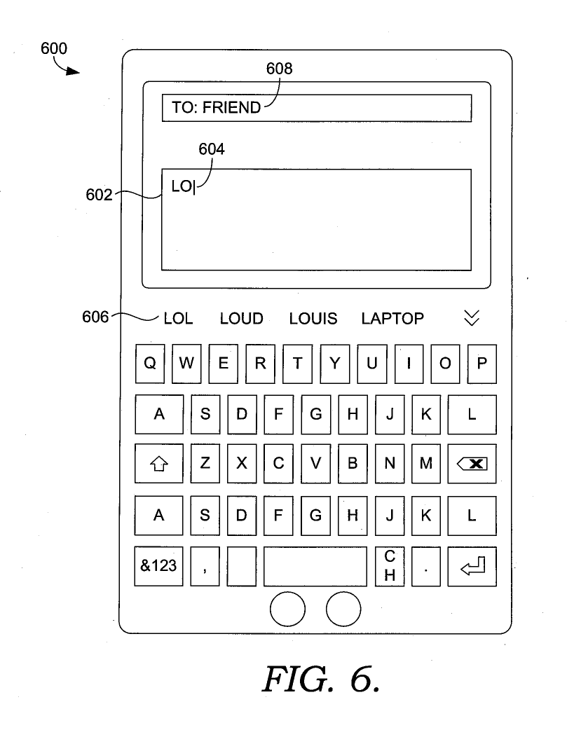

Referring now to FIG. 6, a diagram is provided illustrating an exemplary screen display showing an embodiment of the present invention. The screen display includes message field 602, user input 604, text-selection field 606, and recipient field 608. For example, a user may enter a mobile email application and be presented with a screen resembling the screen depicted in FIG. 6. The user may indicate a communication recipient in recipient field 608. This communication recipient information provides context that may be analyzed and associated with one or more input elements. In addition, this context may be analyzed to identify one or more input elements to advantageously provide to the user. The user may also enter user input 604 in composing a message. User input 604 and communication recipient in recipient field 608 may be analyzed to determine to provide an input element—for example, the choices displayed along text-selection field 606.

For instance, the user may desire to communication with his friend, and may have instantiated an email application to accomplish this task. The email application may present a screen display similar to the screen display depicted in FIG. 6. The user may indicate that the communication recipient would be a friend, as depicted in recipient field 608. The user may then begin to input data in message field 602. The context of friend as the intended communication recipient may be analyzed to determine to utilize a specific dictionary associated with that friend when determining input elements. That specific dictionary may be analyzed, utilizing user input 604, to determine a number of input elements. In this case, input elements “LOL,” “LOUD,” “LOUIS,” and “LAPTOP” may have been determined to be presented to the user for display.

Some of these words may have been previously associated with the context of this friend as a communication recipient, and may thus have been determined to be advantageously provided to the user. For instance, the user may often use the word “LOL” when communicating with a particular friend, or with various communication recipients tagged as being in the “friend” category. Similarly, the user may often use the word “LOUD” when communicating with a particular friend. Additionally, while the user may not have used the word “LOUIS” when communicating with this particular communication recipient, the user may have used that word with other communication recipients. Nonetheless, “LOUIS” may be displayed along text-selection field 606. Finally, the user may never have used to word “LAPTOP” in any communication to any communication recipient, but the word may appear in a default broad dictionary. This word too may be incorporated as an input element along text-selection field 606. These input elements may thus displayed along text-selection field 606. The user may type the remainder of the word, or may choose one of the input elements to indicate the desired input.

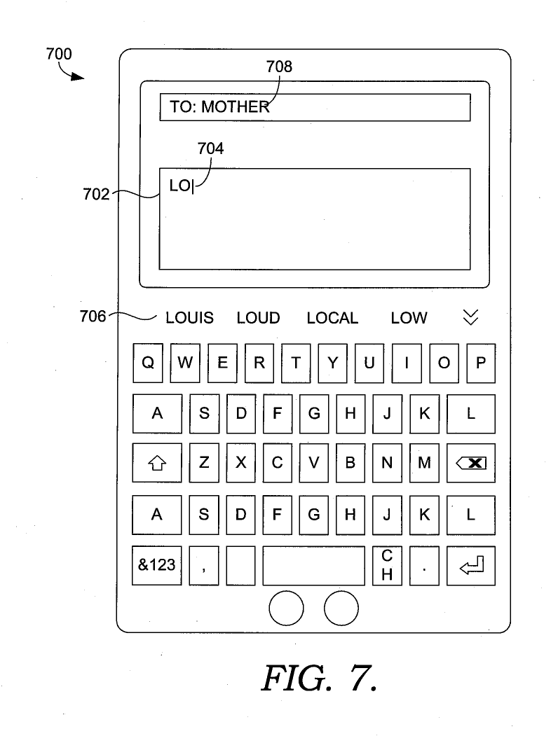

Referring to FIG. 7, another diagram is provided illustrating an exemplary screen display showing another embodiment of the present invention. The screen display includes message field 702, user input 704, text-selection field 706, and recipient field 708. For example, a user may enter a mobile email application and be presented with a screen resembling the screen depicted in FIG. 7. The user may indicate a communication recipient, as shown in recipient field 708. This communication recipient provides context that may be analyzed and associated one or more input elements. In addition, this context may be analyzed to identify one or more input elements to advantageously provide to the user. The user may also enter user input 704 in composing a message. User input 704 and communication recipient in recipient field 708 may be analyzed to determine to provide an input element—for example, the choices displayed in text-selection field 706.

In the instance exemplified in FIG. 7, the user may desire to communication with his mother, and may have instantiated an email application to accomplish this task. The email application may present a screen display similar to the screen display depicted in FIG. 7. The user indicated that the communication recipient would be his mother, as depicted in recipient field 708. The user may then have begun to input data in message field 702. The context of mother as the intended communication recipient may be analyzed to determine to utilize a specific dictionary for use with mother when determining input elements. This specific dictionary may be analyzed, utilizing user input 704, to determine a number of input elements. In this case, input elements “LOUIS,” “LOUD,” “LOCAL,” and “LOW” may have been determined to be presented to the user for display. Some of these words may have been previously associated with the context of mother as a communication recipient. For instance, the user may often use the word “LOUIS” when communicating with his mother. Alternatively, the communication recipient “mother” may have been associated with communication recipient “father,” and while the user had not used the word “LOUIS” with “mother,” he may have used the word “LOUIS” with “father.” Thus, although input element “LOUIS” was not specifically associated with context “mother,” the word may nonetheless be displayed because it was associated with the context “father” (which was in turn associated with context “mother”). Thus, a context may be associated with another context in order to determine input elements.

It should be noted that, although user input 704 is the same as user input 604, the word “LOL” is not depicted as an input element in FIG. 7 as it is in FIG. 6. This may be because it was determined that the user does not use the word “LOL” with mother. For instance, in a previous interaction, the user may have been presented “LOL” as an option in text-selection field 706, but the user might not have chosen “LOL.” Accordingly, the word “LOL” might be negatively associated with context “mother.” Similarly, the user may have indicated that the word “LOL” is not to be presented when in the context of composing an email to communication recipient mother. This negative association may be analyzed to determine not to present “LOL” to the user in this context.

Further, the word “LOUD” appears in text-selection field 706. While the user may not have used the word “LOUD” when communicating with mother as a communication recipient, other user interactions may have been analyzed to determine to present this word. For instance, the user may be in the location of a concert venue. Other users may be near the user, and these users may have composed communication. These user interactions may have contained the word “LOUD” at a higher probability than typically occurs in user communications. These user interactions may have been analyzed, perhaps at a central computer system, to determine to present the word “LOUD” to the user along text-selection field 706. It should be noted that, in this example, “LOUD” could either have been transmitted from a central server to the computing device depicted in FIG. 7, or the central server could have simply provided information used to rank the word “LOUD” such that it appears in its position in text-selection field 706. Thus, third party user interactions may be analyzed in determining to provide an input element to a user.

In some embodiments, multiple contexts and/or multiple input elements may be associated with each other. In such embodiments, the input elements may be ranked against each other based on context and/or relevance to the user. In certain embodiments, user interactions may be analyzed to associate a first input element with a first context, a second input element with a second context, and the first context with the second context. Thus, in such embodiments, the first context may be analyzed to present the second input element to a user.

As can be understood, embodiments of the present invention are directed to context aware input engines. The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media storing computer-useable instructions that, when used by one or more computing devices, cause the one or more computing devices to perform a method, the method comprising:
analyzing a user interaction to associate an input element with a first context;
analyzing a second context to determine to provide the input element to a first user; and
providing the input element to the first user.

2. The one or more computer storage media of claim 1, wherein the first context is equal to the second context.

3. The one or more computer storage media of claim 1, wherein the user interaction was generated by the first user.

4. The one or more computer storage media of claim 1, wherein the first context comprises the location of the user interaction.

5. The one or more computer storage media of claim 1, wherein the first context comprises a communication recipient.

6. The one or more computer storage media of claim 1, wherein the input element comprises a keyboard.

7. The one or more computer storage media of claim 1, wherein the input element comprises a text-selection interface.

8. The one or more computer storage media of claim 7, wherein the text-selection interface comprises text from a dictionary, the dictionary being associated with the first context.

9. The one or more computer storage media of claim 1, wherein the first context comprises a communication recipient, the second context comprises the communication recipient, the input element comprises a communication.

10. The one or more computer storage media of claim 1, wherein the user interaction comprises selecting the input element.

11. The one or more computer storage media of claim 10, wherein the first context comprises the application providing for the user interaction.

12. The one or more computer storage media of claim 1, wherein the input element comprises a voice recognition engine.

13. A computing device, comprising:
an input device for receiving input from a user;
one or more processors configured to execute a method for analyzing a first context to determine a first dictionary associated with the first context, analyzing the data obtained from the input device to select a first word from the first dictionary, and providing the first word to the user as a selection-option; and
a display device configured to present the first selection-option to the user.

14. The computing device of claim 13, wherein the input comprises a character.

15. The computing device of claim 13, wherein the first dictionary comprises tags associating one or more words with one or more contexts.

16. The computing device of claim 13, wherein the first word comprises a user-generated word, and wherein the first context comprises a communication recipient.

17. The computing device of claim 16, further comprising:
a memory device configured to store the user-generated word, and wherein the one or more processors are configured to associate the user-generated word with the communication recipient.

18. The computing device of claim 13, wherein the one or more processors are configured to determine a second dictionary, analyze the input to select a second word from the second dictionary, and assign a first rank to the first word and a second rank to the second word.

19. The computing device of claim 13, wherein the one or more processors are configured to analyze a second context.

20. An input element presentation system including one or more computing devices having one or more processors and one or more computer storage media, the input element presentation system comprising:
a context identification component;
an association component for associating contexts with input elements;
an input element identification component for identifying input elements based on analyzing contexts; and
a presentation component for presenting input elements to a user.
